(19) United States
(12) Patent Application Publication
(10) Pub. No.: US 2016/0221414 A1
(43) Pub. Date: Aug. 4, 2016

(54) AIR CONDITIONING UNIT

(71) Applicant: DENSO CORPORATION, Kariya-city (JP)

(72) Inventors: Takahito NAKAMURA, Kariya-city (JP); Yoshihiro GOTOH, Kariya-city (JP)

(21) Appl. No.: 15/022,772

(22) PCT Filed: Aug. 21, 2014
(86) PCT No.: PCT/JP2014/004272

§ 371 Date: Mar. 17, 2016

(30) Foreign Application Priority Data
Sep. 20, 2013 (JP) 2013-195508
Jul. 15, 2014 (JP) 2014-145210

(51) Int. Cl. B60H 1/00

(52) U.S. Cl. CPC B60H 1/00535; B60H 1/00328; B60H 1/00428; B60H 1/00057; B60H 2001/006; B60H 2001/00221; B60H 2001/00242; B60H 2001/00092; B60H 2001/00099; B60H 2001/00085; B60H 2001/00235

(57) ABSTRACT

An air conditioning unit has an air conditioning case, a blower, and a heat exchanger. The air conditioning case is arranged in a vehicle compartment on a rear side with respect to an instrument panel in a traveling direction of a vehicle and forms an air passage delivering air toward a specified area of the vehicle compartment. The blower has at least first and second impellers and a fan case housing the first and second impellers, and ventilates the air in the air conditioning case by drawing and blowing air, by using a rotation of the first and second impellers, through first and second suction ports formed in the fan case. The heat exchanger is arranged in the air conditioning case on an upstream side of the blower in an airflow direction and exchanges heat of the air. The blower draws air from the heat exchanger and blows the air to the specified area of the vehicle compartment. The fan case has a portion in which at least the first and second suction ports are formed, and the portion is arranged inside of the air conditioning case.

### CROSS REFERENCE TO RELATED APPLICATIONS

This application is based on Japanese Patent Application No. 2013-195508 filed on Sep. 20, 2013 and Japanese Patent Application No. 2014-145210 filed on Jul. 15, 2014, the disclosure of which is incorporated herein by reference.

### TECHNICAL FIELD

The present disclosure relates to an air conditioning unit.

### BACKGROUND ART

Conventionally, an air conditioning unit for a rear seat is known to have an air conditioning case, a blower that draws air into a vehicle compartment and ventilates the air in the air conditioning case, a cooling heat exchanger that is disposed in the air conditioning case and cools the air by refrigerant, and a heating heat exchanger that is disposed in the air conditioning case and heats a cool air blown from the cooling heat exchanger by a warm water. The air conditioning unit for a rear seat blows air of which temperature is adjusted by the cooling heat exchanger and the heating heat exchanger to a rear seat side in the vehicle compartment (refer Patent Literatures 1 and 2).

### PRIOR ART LITERATURES

### Patent Literature

Patent Literature 1: JP H10-236137 A

Patent Literature 2: JP 2000-168346 A

### SUMMARY OF INVENTION

Inventors of the present disclosure considered mounting an air conditioning unit 10A for a rear seat between an outer plate 2 and a quarter trim 3 as shown in FIG. 10. The quarter trim 3 is an inner wall that is arranged on a rear side with respect to a front seat in a vehicle compartment in a traveling direction of a vehicle and is exposed to the vehicle compartment.

Recent vehicles tend to have a larger passenger space for a purpose of a comfort of a passenger. In conjunction of the trend, a mounting space in which the air conditioning unit 10A for a rear seat is mounted between the outer plate 2 and the quarter trim 3 is getting smaller. Accordingly, a speed of air (refer an arrow Ya in FIG. 10) that is drawn by a blower 30A increases. Then, a pressure loss of the air increases, and a noise is caused. Therefore, even if an air introducing port of the blower 30A is open toward the outer plate side, the noise that is caused when the blower 30A draws air is reflected on the outer plate 2 and transmits into the vehicle compartment through the quarter trim 3, and the passenger may feel uncomfortable.

The noise is not limited to cause in a case where the air conditioning unit 10A for a rear seat is mounted between the outer plate 2 and the quarter trim 3, and causes in a case where the air conditioning unit 10A for a rear seat is mounted in a center console or a roof part. Moreover, a similar noise may be caused in an air conditioning unit blowing air to an area except for the rear seat side in the vehicle compartment.

The present disclosure addresses the above issues, and it is an objective of the present disclosure to provide an air conditioning unit with which a noise that transmits from a blower into a vehicle compartment can be reduced.

An air conditioning unit of the present disclosure has an air conditioning case, a blower, and a heat exchanger. The air conditioning case is arranged in a vehicle compartment on a rear side with respect to an instrument panel in a traveling direction of a vehicle and forms an air passage delivering air toward a specified area of the vehicle compartment. The blower has at least first and second impellers and a fan case housing the first and second impellers, and ventilates the air in the air conditioning case by drawing and blowing air, by using a rotation of the first and second impellers, through first and second suction ports formed in the fan case. The heat exchanger is arranged in the air conditioning case on an upstream side of the blower in an airflow direction and exchanges heat of the air. The blower draws air from the heat exchanger and blows the air to the specified area of the vehicle compartment. The fan case has a portion in which at least the first and second suction ports are formed, and the portion is arranged inside of the air conditioning case.

According to the air conditioning unit of the present disclosure, the fan case has the portion in which at least the first and second suction ports are formed, and the portion is arranged inside of the air conditioning case. Accordingly, when the blower draws air and causes a noise, an inner wall of the air conditioning case can suppress a transmission of the noise into the vehicle compartment. In addition, since the blower draws air from both of the first and second suction ports, a total area of the suction ports can be increased as compared to that of a blower drawing air from a single suction port. Accordingly, a pressure loss of air drawn by the blower decreases, and a flow speed of the air can decrease. Therefore, a noise caused when the blower draws air can be reduced. Thus, a noise transmitting from the blower into the vehicle compartment can be reduced.

### BRIEF DESCRIPTION OF DRAWINGS

FIG. 1 is a perspective diagram illustrating an air conditioning unit for a rear seat according to a first embodiment of the present disclosure is mounted in a vehicle.

FIG. 2 is a perspective view illustrating the air conditioning unit for a rear seat except for an air conditioning case.

FIG. 3 is a view corresponding to a sectional view taken along a line III-III shown in FIG. 2 and illustrating a condition where the air conditioning unit for a rear seat is mounted in the vehicle.

FIG. 4 is a sectional view illustrating an air conditioning unit for a rear seat according to a second embodiment of the present disclosure.

FIG. 5 is a perspective diagram illustrating a condition where an air conditioning unit for a rear seat according to a third embodiment of the present disclosure is mounted in a vehicle.

FIG. 6 is a perspective diagram illustrating a condition where an air conditioning unit for a rear seat according to a fourth embodiment of the present disclosure is mounted in a vehicle.

FIG. 7 is a perspective diagram illustrating a condition where an air conditioning unit for a rear seat according to a fifth embodiment of the present disclosure is mounted in a vehicle.

FIG. 8 is a diagram illustrating a configuration of an air conditioning unit for a rear seat according to a sixth embodiment of the present disclosure.

FIG. 9 is a diagram illustrating a configuration of an air conditioning unit for a rear seat according to a seventh embodiment of the present disclosure.

FIG. 10 is a sectional view illustrating an air conditioning unit for a rear seat according to a comparison example of the present disclosure.

### DESCRIPTION OF EMBODIMENTS

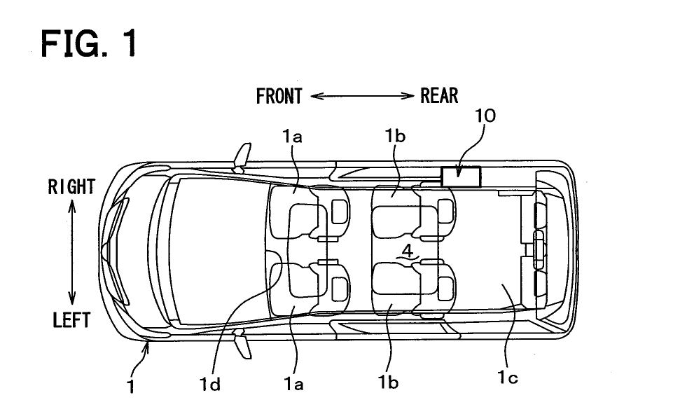

Embodiments of the present disclosure will be described hereafter referring to drawings. In the embodiments, a part that corresponds to or equivalents to a matter described in a preceding embodiment may be assigned with the same reference number to simplify the description. In the flowing description, “front”, “rear”, “left”, “right”, “upper”, and “lower” will be referred on a traveling-direction basis on a condition of a vehicle traveling normally as shown, for example, in FIG. 1.

### First Embodiment

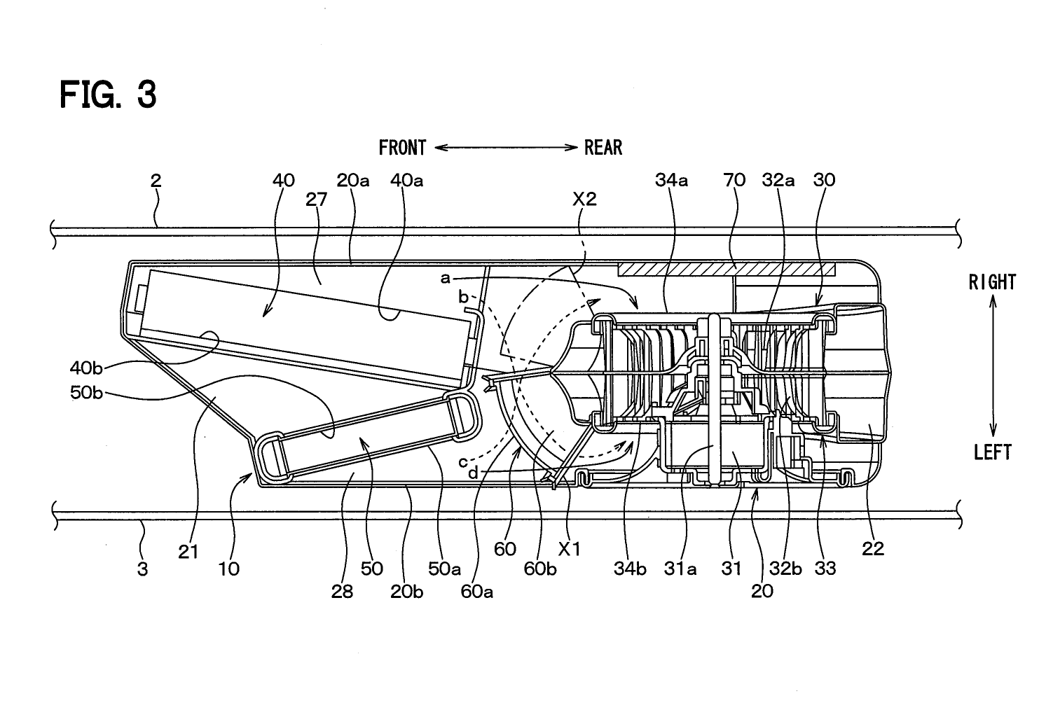

FIGS. 1, 2, and 3 shows an air conditioner for a vehicle according to the present embodiment of the present disclosure. Arrows in FIGS. 1 and 3 shows directions on a condition of being mounted in the vehicle.

A vehicle 1 in which the air conditioner for a vehicle is mounted has a rear space 1c in a vehicle compartment on a rear side with respect to a front seat 1a and a rear seat 1b in a traveling direction of the vehicle. The rear space 1c is used to dispose a rearmost seat therein or used as a luggage room.

The air conditioner for a vehicle of the present embodiment further has an air conditioning unit 10 for a rear seat that performs an air-conditioning of a rear seat side in the vehicle compartment in addition to an air conditioning unit for a front seat (not shown) that performs an air-conditioning of a front seat side in the vehicle compartment.

The air conditioning unit for a front seat is well-known to be arranged in a substantially center part in a left-right direction (i.e., a width direction) of the vehicle inside of an instrument panel 1d (i.e., a dashboard) that is located in a foremost area of the vehicle compartment. Accordingly, a description about the air conditioning unit for a front seat will be omitted.

As shown in FIG. 1, the air conditioning unit 10 for a rear seat is arranged on a rear side with respect to the front seat 1a in the vehicle compartment. That is, the air conditioning unit 10 is arranged on a rear side with respect to the instrument panel 1d. More specifically, the air conditioning unit 10 for a rear seat is arranged on a rear side of a rear side door. The air conditioning unit 10 for a rear seat of the present embodiment is arranged on a right side in the vehicle.

The air conditioning unit 10 for a rear seat is arranged between an outer plate 2 and a quarter trim 3, as shown in FIG. 3. The outer plate 2 is located outside on the right side of the vehicle 1. The quarter trim 3 is an inner wall arranged on a rear side with respect to the front seat 1a in the vehicle compartment.

The air conditioning unit 10 for a rear seat constitutes a so-called “fan suction layout” that is constituted by arranging a blower 30 on a most downstream side in an airflow direction in an air conditioning case 20.

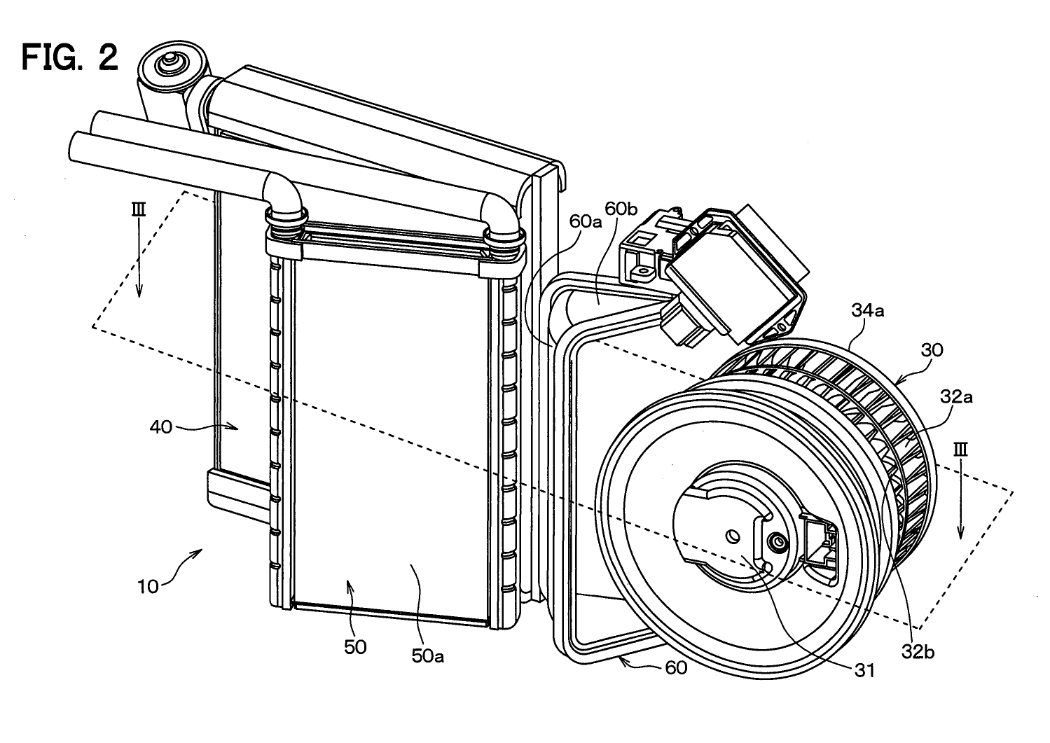

Specifically, the air conditioning unit 10 for a rear seat has the air conditioning case 20, the blower 30, an evaporator 40, a heater core 50, and an air mix door 60, as shown in FIGS. 2 and 3. Illustration of the air conditioning case 20 is omitted in FIG. 2.

The air conditioning case 20 forms an outer shell of the air conditioning unit 10 for a rear seat and an air passage through which air ventilated toward the rear seat side flows. The air conditioning case 20 has a certain level of elasticity and is formed by resin (for example, polypropylene) that is excellent in intensity.

An introducing port 21 introducing air from inside of the vehicle compartment is formed in a front side in the air conditioning case 20 on a most upstream side in the air passage that is formed in the air conditioning case 20. The introducing port 21 is open frontwards.

The blower 30 is arranged on a most downstream side in the air flow direction with respect to the air conditioning case 20. The blower 30 constitutes a so-called “both-suction double fans” that draws air from two suction ports 34a, 34b by two impellers 32a, 32b. Specifically, the blower 30 is a centrifugal-type multi-blade blower having an electric motor 31, impellers 32a, 32b, and a fan case 33. In the present embodiment, a sirocco fan is used as the blower 30.

The electric motor 31 rotates the impellers 32a and 32b by a rotation shaft 31a. The rotation shaft 31a of the electric motor 31 is arranged to extend in the left-right direction. The impellers 32a, 32b are a centrifugal-type multi-blade fan and are arranged on a right side with respect to the electric motor 31. The impellers 32a and 32b are fixed to the rotation shaft 31a of the electric motor 31. The impeller 32a is arranged on a right side of the impeller 32b. The impeller 32a draws air through the suction port 34a and blows the air outward in a radial direction by rotating. The impeller 32b draws air through the suction port 34b and blows the air outward in the radial direction by rotating.

The suction ports 34a and 34b are formed by the fan case 33, respectively. The suction port 34a is open on a right side of the blower 30. That is, the suction port 34a faces an inner wall that is provided with a right wall portion 20a of the air conditioning case 20. In other words, the fan case 33 has a portion that is provided with the suction port 34a, and the portion is arranged inside of the air conditioning case 20.

The suction port 34b is open on a left side of the blower 30. Accordingly, the suction port 34b faces an inner wall that is provided with a left wall portion 20b of the air conditioning case 20. That is, the fan case 33 has a portion that is provided with the suction port 34b, and the portion is arranged inside of the air conditioning case 20. The fan case 33 is arranged on an outer side with respect to the impellers 32a, 32b in the radial direction centered at the rotation shaft 31a. That is, the fan case 33 has the suction ports 34a, 34b and houses the impellers 32a, 32b.

The fan case 33 collects air that is blown from the impellers 32a, 32b and blows the air from a blowing opening 22. The blowing opening 22 connects to various blowing outlets through a duct that is not shown. The blowing outlets are open in a rear-seat side space 4 in the vehicle compartment.

The evaporator 40 is arranged in the air conditioning case 20 on an upstream side of the blower 30 in the airflow direction. The evaporator 40 is one of devices configuring a well-known vapor-compression type refrigerant cycle (not shown), and is a cooling heat exchanger cooling air that is to be blown into the vehicle compartment by exerting an absorption effect caused by evaporating a low-pressure refrigerant in the refrigerant cycle.

The evaporator 40 is configured by tubes, first and second tanks, and a heat exchanging fin to have a flat shape. The tubes are arranged in a direction perpendicular to the airflow direction. The first tank distributes refrigerant from an expansion valve to each of the tubes. The second tank collects refrigerant flowing out of the tubes and delivers the refrigerant to a compressor side. The heat exchanging fin is arranged on a surface of each of the tubes and promotes a heat exchange between refrigerant and air. Thus, air passes through the evaporator 40 in a thickness direction of the evaporator 40, and the evaporator 40 cools the air by refrigerant and blows cool air.

According to the present embodiment, the evaporator 40 has an air outlet surface 40a as a cool-air blowing surface blowing cool air, and the evaporator 40 is arranged such that the air outlet surface 40a faces rightward. The air outlet surface 40a of the evaporator 40 is arranged to incline with respect to the traveling direction of the vehicle. The air outlet surface 40a is a heat radiating surface that is provided with the evaporator 40 in the thickness direction and located on a downstream side in the evaporator 40.

The heater core 50 is arranged on the upstream side of the blower 30 in the airflow direction in the air conditioning case 20. The heater core 50 is a heating heat exchanger that heats air to be blown into the vehicle compartment by engine cooling water (i.e., warm water) and blows warm air.

Specifically, the heater core 50 is configured by tubes, first and second tanks, and a heat exchanging fin to have a flat shape. The tubes are arranged in a direction perpendicular to the airflow direction. The first tank distributes engine cooling water from a side of an engine for traveling to each of the tubes. The second tank collects engine cooling water flowing from the tubes and delivers to the side of the engine for traveling. The heat exchanging fin is arranged on a surface of each of the tubes and promotes a heat exchange between engine cooling water and air. Accordingly, air passes through the heater core 50 in a thickness direction of the heater core 50, and the heater core 50 heats air by engine cooling water and blows warm air.

The heater core 50 has an air outlet surface 50a as a warm-air blowing surface blowing warm air, and the evaporator 40 is arranged such that the air outlet surface 50a faces leftward. The air outlet surface 50a of the heater core 50 is arranged to incline with respect to the traveling direction of the vehicle. The air outlet surface 50a is a heat radiating surface that is provided with the heater core 50 in the thickness direction and located on a downstream side in the heater core 50.

According to the present embodiment, the evaporator 40 and the heater core 50 are arranged in parallel in a direction intersecting with the airflow direction. A condition where the evaporator 40 and the heater core 50 are arranged in parallel in the direction intersecting with the airflow direction includes a condition where the evaporator 40 and the heater core 50 are arranged to be adjacent to each other in a direction intersecting with the airflow direction. Accordingly, similar to the present embodiment, the evaporator 40 and the heater core 50 may not be arranged to be parallel with each other and may incline to each other. The evaporator 40 and the heater core 50 are arranged in V-shape such that a dimension between the air inlet surface 40b and the air inlet surface 50b increases toward an upstream side in the airflow direction (i.e., toward a front side of the vehicle).

The air inlet surface 50b is a portion of the heater core 50 to which air introduced from the introducing port 21 flows. The air inlet surface 40b is a portion of the evaporator 40 to which air introduced from the introducing port 21 flows.

An outflow passage 27 is formed between the air outlet surface 40a of the evaporator 40 and the right wall portion 20a of the air conditioning case 20. The outflow passage 27 is a passage that delivers cool air, which is blown from the evaporator 40, toward the blower 30.

An outflow passage 28 is formed between the air outlet surface 50a of the heater core 50 and the left wall portion 20b. The outflow passage 28 is a passage that delivers warm air, which is blown from the heater core 50, toward the blower 30. The air mix door 60 is arranged on a downstream side in the airflow direction with respect to the outflow passages 27, 28. The air mix door 60 is operated by the electric motor 61 and supported swingably. The air mix door 60 moves rotatably in a range between a position X1 shown by a solid line and a position X2 shown by a chain line, and changes a ratio between an air volume passing through the outflow passage 27 and an air volume passing through the outflow passage 28 by changing a ratio between an opening area of the outflow passage 27 and an opening area of the outflow passage 28.

Specifically, the air mix door 60 has a shield portion 60a and an guiding path 60b. The shield portion 60a closes an opening portion of one of the outflow passages 27, 28. The guiding path 60b guides warm air from the outflow passage 28 to flow to the suction port 34a as shown by an arrow c, and guides cool air flowing from the outflow passage 27 to flow to the suction port 34b as shown by an arrow b. Thus, depending on a rotational position of the air mix door 60, the ratio between an air volume of warm air flowing from the heater core 50 to the suction ports 34a, 34b and an air volume of cool air flowing from the evaporator 40 to the suction ports 34a, 34b.

According to the present embodiment, a sound absorption member 70 is fixed to the inner wall of the right wall portion 20a of the air conditioning case 20. The sound absorption member 70 is formed to cover the suction port 34a around the suction port 34a. The sound absorption member 70 is a sound absorber configured by a sound absorption material such as foamed polyurethane to have a plate shape.

An operation of the air conditioning unit 10 for a rear seat according to the present embodiment will be described hereafter.

When the electric motor 31 rotates the impellers 32a, 32b in the blower 30, air flows in the air conditioning case 20 from the introducing port 21 to the blower 30.

A part of air flowing into the air conditioning case 20 passes the evaporator 40 in the thickness direction. On this occasion, the air is cooled by refrigerant in the tubes and is blown from the air outlet surface 40a as cool air. The cool air blown from the air outlet surface 40a flows from the outflow passage 27 toward a side of the blower 30.

On the other hand, a remaining air other than a part of air flowing to a side of the evaporator 40 among the air blowing from the introducing port 21 passes the heater core 50 in the thickness direction. On this occasion, the remaining air is heated by the engine cooling water (i.e., warm water) while being passing through the heater core 50. Accordingly, warm air flows from the air outlet surface 50a of the heater core 50 to a side of the blower 30 through the outflow passage 28. Thus, cool air flowing from the outflow passage 27 and warm air flowing from the outflow passage 28 flows to the side of the blower 30.

The blower 30 draws air flowing from the outflow passages 27, 28 through the suction ports 34a, 34b as shown by the arrows a, b, c, d, mixes the air, and blows the air as a conditioned air from the blowing opening 22 through the fan case 33. The blown conditioned air blows from the blowing outlets to the rear-seat side space 4 of the vehicle compartment through the duct.

Here, although a noise occurs when the air flowing from the outflow passages 27, 28 is drawn by the suction ports 34a, 34b, the noise can be prevented from transmitting into the vehicle compartment by a wall surface of air conditioning case 20. In addition, the noise caused when the air flowing from the outflow passages 27, 28 is drawn by the suction ports 34a and 34b is absorbed by the sound absorption member 70.

According to the present embodiment, the ratio between an air volume of cool air passing through the outflow passage 27 and an air volume of warm air passing through the outflow passage 28 is set by the air mix door 60. Therefore, a temperature of air blowing from the blowing opening 22 to a side of the rear-seat side space 4 through the duct and blowing outlets is set by a rotational position of the air mix door 60.

The position X1 shown in FIG. 3 shows an example where the air mix door 60 fully opens the outflow passage 27 and fully closes the outflow passage 28. The position X2 shown in FIG. 3 shows an example where the air mix door 60 fully closes the outflow passage 27 and fully opens the outflow passage 28.

According to the above-described present embodiment, the air conditioning unit 10 for a rear seat includes the air conditioning case 20 (i) that is disposed between the inner wall, which is arranged in the vehicle compartment on the rear side with respect to the front seat, and the outer plate 2, which is arranged on the outer side in the vehicle in the left-right direction, and (ii) that delivers air to the rear seat side in the vehicle compartment. The air conditioning unit 10 has the blower 30, the evaporator 40, and the heater core 50. The blower 30 ventilates air in the air conditioning case 20 by drawing and blowing air by using a rotation of the impellers 32a, 32b centered at the rotation shaft 31a. The evaporator 40 and the heater core 50 are arranged on the upstream side of the blower 30 in the air conditioning case 20 and exchange heat with air. By ventilating air by using a rotation of the impellers 32a, 32b of the blower 30, air from the evaporator 40 and the heater core 50 is drawn through the suction ports 34a, 34b and blown to the rear seat side in the vehicle compartment. The portion of the fan case 33 that is provided with at least the suction ports 34a, 34b is arranged inside of the air conditioning case 20. Thus, the suction ports 34a, 34b are surrounded by an inner wall of the air conditioning case 20.

Accordingly, when the blower 30 draws air flowing from the evaporator 40 and the heater core 50 and causes a noise, the inner wall of the air conditioning case 20 can suppress a transmission of the noise into the vehicle compartment. That is, the noise caused when the blower 30 draws air can be shut up in the air conditioning case 20. In addition, since the blower 30 draws air from both of the suction ports 34a, 34b, a total area of the suction ports (34a, 34b) can be increased as compared to that of a blower drawing air from a single suction port. Accordingly, a pressure loss of air drawn by the blower 30 decreases, and a flow speed of the air can decrease. Therefore, a noise caused when the blower 30 draws air can be reduced. Thus, a noise transmitting from the blower 30 into the vehicle compartment can be reduced.

According to the present embodiment, the sound absorption member 70 absorbing sound caused when the blower 30 draws air is disposed in the air conditioning case 20. Therefore, a noise transmitting from the blower 30 into the vehicle compartment can be certainly suppressed.

According to the present embodiment, the evaporator 40 is arranged such that the air outlet surface 40a faces rightward. The hater core 50 is arranged such that the air outlet surface 50a faces leftward. Therefore, a dimension of the air conditioning case 20 in the left-right direction can be smaller as compared to a case where the evaporator 40 is arranged such that the air outlet surface 40a faces in an upper-lower direction and the heater core 50 is arranged such that the air outlet surface 50a faces in the upper-lower direction.

### Second Embodiment

In the above-described first embodiment, an example in which the evaporator 40 and the heater core 50 are arranged in parallel in a direction intersecting with the airflow direction is described. In an second embodiment, an example in which the evaporator 40 and the heater core 50 are arranged in series in the airflow direction.

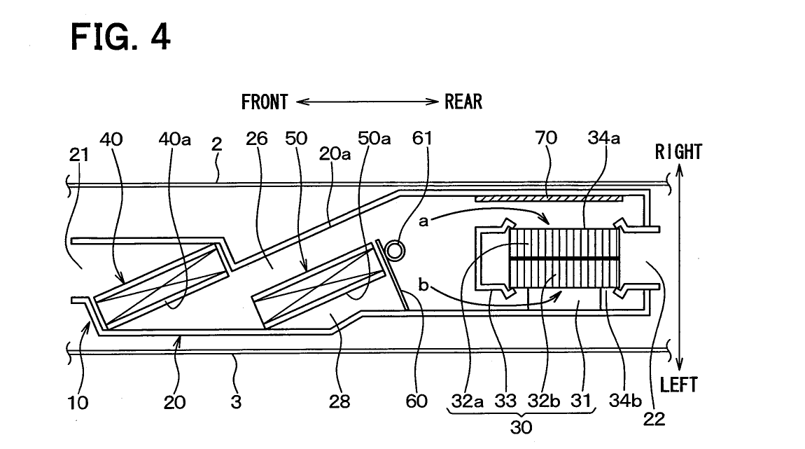

FIG. 4 is a sectional view illustrating an air conditioning unit 10 for a rear seat according to the second embodiment of the present disclosure.

The air conditioning unit 10 for a rear seat has the air conditioning case 20, the blower 30, and the air mix door 60. In FIG. 4, the same reference numbers as FIG. 2 show the same members, and the explanation is simplified.

According to the present embodiment, the evaporator 40 is arranged such that the air outlet surface 40a faces leftward. The air outlet surface 40a of the evaporator 40 is arranged to incline with respect to the traveling direction. The heater core 50 is arranged on a downstream side with respect to the evaporator 40 in the airflow direction. That is, the heater core 50 and the evaporator 40 are arranged in series in the airflow direction. The heater core 50 is arranged such that the air outlet surface 50a faces leftward. The air outlet surface 50a of the heater core 50 is arranged to incline with respect to the traveling direction.

According to the present embodiment, the evaporator 40 and the heater core 50 are arranged such that the air outlet surface 40a and the air outlet surface 50a are located to be parallel with each other. A bypass passage 26 is formed between the air outlet surface 50a of the heater core 50 and the right wall portion 20a of the air conditioning case 20. The bypass passage 26 is a passage that delivers cool air blowing from the evaporator 40 to a side of the blower 30 while bypassing the heater core 50.

The air mix door 60 is arranged on a downstream side with respect to the heater core 50 in the airflow direction. The air mix door 60 of the present embodiment is provided with a slide type door that is arranged to be moved slidably by the electric motor 61. The air mix door 60 changes a ratio between an air volume passing through the bypass passage 26 and an air volume passing through the outflow passage 27 by changing a ratio between an opening area of the bypass passage 26 and an opening area of the outflow passage 27

Similar to the above-described first embodiment, the blower 30 of the present embodiment draws air from the suction ports 34a, 34b by a rotation of the impellers 32a, 32b and blows the air from the blowing opening 22 of the fan case 33. The portion of the fan case 33 that is provided with at least the suction ports 34a, 34b is arranged inside of the air conditioning case 20. Thus, the suction ports 34a, 34b are surrounded by the inner wall of the air conditioning case 20. In FIG. 4, illustration of the rotation shaft 31a of the electric motor 31 is omitted.

An operation of the air conditioning unit 10 for a rear seat according to the present embodiment will be described hereafter.

When the electric motor 31 rotates the impellers 32a, 32b in the blower 30, air is introduced into the air conditioning case 20 from the introducing port 21. Accordingly, air flows toward the blower 30 from the introducing port 21 in the air conditioning case 20.

Air flowing in the air conditioning case 20 passes the evaporator 40. In this case, air is cooled by refrigerant in the tubes and blown from the air outlet surface 40a as a cool air. A part of the blowing cool air passes the bypass passage 26 and flows to a side of the blower 30.

On the other hand, a remaining cool air other than the cool air passing through the bypass passage 26 among the cool air blowing from the air outlet surface 40a passes the heater core 50. On this occasion, the remaining cool air is heated by warm water in the tubes when passing through the heater core 50. Accordingly, a warm air from the air outlet surface 50a of the heater core 50 flows to the side of the blower 30. Thus, the cool air flowing from the bypass passage 26 and the warm air flowing from the heater core 50 flow to a side of the suction ports 34a, 34b of the blower 30 as shown by arrows a, b.

The blower 30, with rotation of the impellers 32a and 32b, draws air, which flows from the outflow passages 27, 28, through the suction ports 34a, 34b and blows the air from the blowing opening 22 through the fan case 33. The blown air is blown into the rear-seat side space 4 in the vehicle compartment from the blowing outlets through the duct.

Here, a ratio between an air volume of cool air flowing from the bypass passage 26 and an air volume of warm air flowing from the heater core 50 is set by the air mix door 60. Accordingly, a temperature of air blowing from the blowing opening 22 into the rear-seat side space 4 through the duct and the blowing outlets is set depending on a rotational position of the air mix door 60.

According to the above-described present embodiment, similar to the above-described first embodiment, the portion of the fan case 33 provided with at least the suction ports 34a, 34b is arranged inside of the air conditioning case 20. Thus, the suction ports 34a, 34b are surrounded by the inner wall of the air conditioning case 20. Even if a noise is caused when the blower 30 draws air flowing from the evaporator 40 and the heater core 50, the inner wall of the air conditioning case 20 can suppress a transmission of the noise into the vehicle compartment. In addition, since the impellers 32a, 32b of the blower 30 draws air from both of the suction ports 34a, 34b, a total area of the suction ports (34a, 34b) can be increased as compared to that of a blower drawing air from a single suction port. Accordingly, a flow speed of air drawn by the blower 30 can decrease. Therefore, a noise caused when the blower 30 draws air can be reduced. Thus, a noise transmitting from the blower 30 into the vehicle compartment can be reduced.

### Third Embodiment

In the above-described first and second embodiments, the air conditioning unit 10 for a rear seat is arranged between the outer plate 2 and the quarter trim 3. In a third embodiment, an air conditioning unit 10 for a rear seat is arranged between a driver seat (Dr) and a passenger seat (Pa).

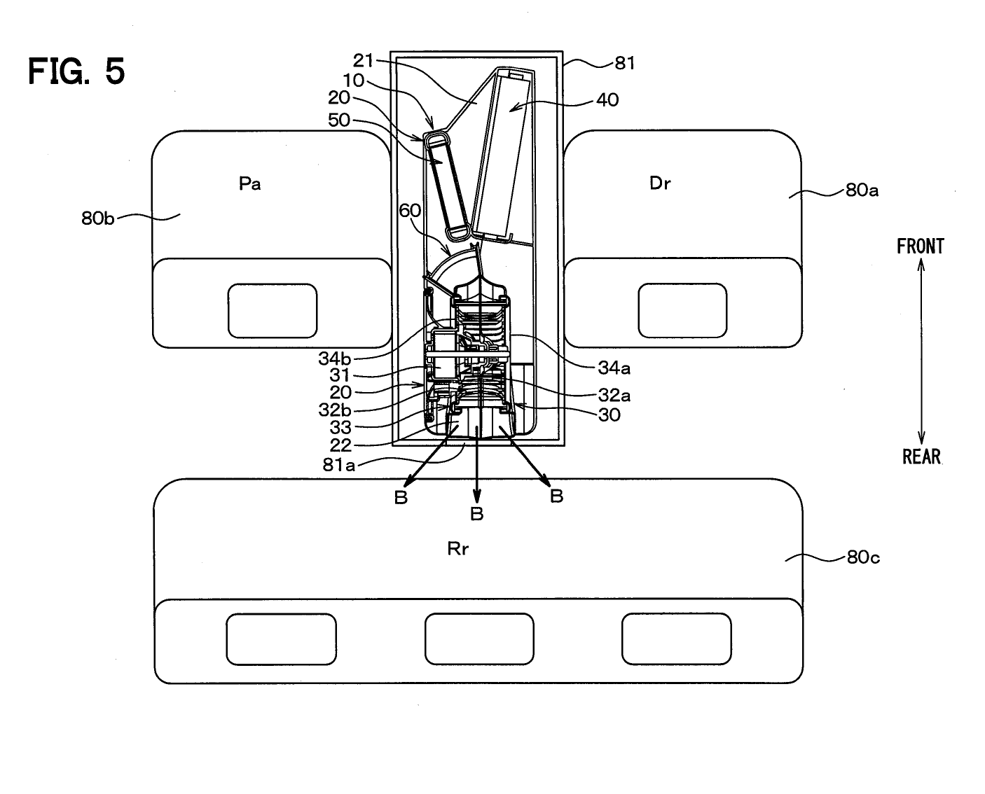

FIG. 5 is a diagram illustrating a condition where an air conditioning unit 10 for a rear seat according to a third embodiment of the present disclosure is mounted in a vehicle. FIG. 5 is an overhead view of the vehicle compartment.

The air conditioning unit 10 for a rear seat of the present embodiment is arranged on a rear side of the instrument panel 1d. More specifically, the air conditioning unit 10 for a rear seat is arranged between a driver seat 80a and a passenger seat 80b on a front side with respect to the rear seat 80c. The driver seat 80a and the passenger seat 80b are arranged in the left-right direction. The air conditioning unit 10 for a rear seat is arranged inside of a center console box 81. The blowing opening 22 of the air conditioning unit 10 for a rear seat is arranged to face a rear side. A conditioned air blown from the blowing opening 22 of the air conditioning unit 10 for a rear seat is blown to a rear side in the vehicle compartment through a blowing outlet 81a of the center console box 81. FIG. 5 shows an example in which a front right-side seat is defined to as the driver seat 80a, and a front left-side seat is defined to as the passenger seat 80b. A configuration of the air conditioning unit 10 for a rear seat according to the present embodiment is the same as that of the air conditioning unit 10 for a rear seat of the above-described first embodiment, thereby a description thereof is omitted.

According to the above-described present embodiment, the portion of the fan case 33 of the blower 30 that is provided with at least the suction ports 34a, 34b is arranged inside of the air conditioning case 20, similar to the above-described first embodiment. Thus, the suction ports 34a, 34b are surrounded by the inner wall of the air conditioning case 20. Accordingly, when the blower 30 draws air and causes a noise, the inner wall of the air conditioning case 20 can suppress a transmission of the noise into the vehicle compartment. In addition, since the impellers 32a, 32b of the blower 30 draws air from both of the suction ports 34a, 34b, a total area of the suction ports (34a, 34b) can be increased as compared to that of a blower drawing air from a single suction port. Accordingly, a flow speed of air drawn by the blower 30 can decrease. Therefore, a noise caused when the blower 30 draws air can be reduced. Thus, a noise transmitting from the blower 30 into the vehicle compartment can be reduced.

### Fourth Embodiment

In the above-described third embodiment, the air conditioning unit 10 for a rear seat is arranged between the driver seat (Dr) and the passenger seat (Pa). In a fourth embodiment, an air conditioning unit 10 for a rear seat is disposed in a roof part.

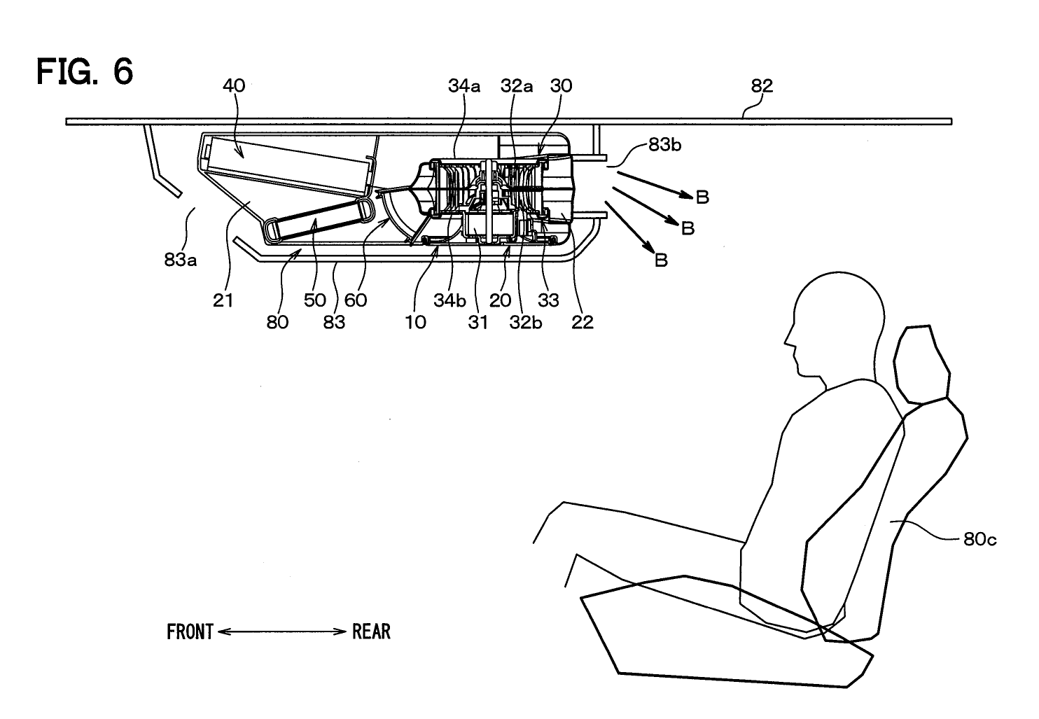

FIG. 6 is a diagram illustrating a condition where the air conditioning unit 10 for a rear seat according to the fourth embodiment of the present disclosure is mounted in a vehicle. FIG. 6 is a diagram of the vehicle compartment when viewed from the width direction (i.e., the left-right direction).

The air conditioning unit 10 for a rear seat of the present embodiment is arranged in a roof part 82 in the vehicle compartment on a rear side with respect to the instrument panel 1d. Specifically, the air conditioning unit 10 for a rear seat is arranged on a lower side of the roof part 82. The air conditioning unit 10 for a rear seat is covered by a face wall 83 from a lower side in the upper-lower direction. The face wall 83 has a suction port 83a opening toward a front side and a blowing outlet 83b opening toward a rear side. The air conditioning unit 10 for a rear seat adjusts a temperature of air, which is drawn from the vehicle compartment through the suction port 83a, by the evaporator 40 and the heater core 50 and blows the air from the blowing outlet 83b to a side of the rear seat 80c through the blowing opening 22.

According to the above-described present embodiment, similar to the first through fourth embodiments, the portion of the fan case 33 of the blower 30 that is provided with at least the suction ports 34a, 34b is arranged inside of the air conditioning case 20. Thus, the suction ports 34a, 34b are surrounded by the inner wall of the air conditioning case 20. Accordingly, the present disclosure provides the same effect as the first through fourth embodiments.

When the air conditioning unit 10 for a rear seat is arranged on a side of the roof part 82, the blowing opening 22 and the blowing outlet 83b of the air conditioning unit 10 for a rear seat are arranged in a position near ears of a passenger seating the rear seat. Accordingly, since the suction ports 34a, 34b are surrounded by the inner wall of the air conditioning case 20, an effect that reduces a noise of the blower 30 can be improved.

### Fifth Embodiment

In the above-described third embodiment, the air conditioning unit 10 for a rear seat is arranged between the driver seat (Dr) and the passenger seat (Pa). In a fifth embodiment, an air conditioning unit 10 for a rear seat is disposed in the vehicle compartment on a rear side of a rearmost seat 80d.

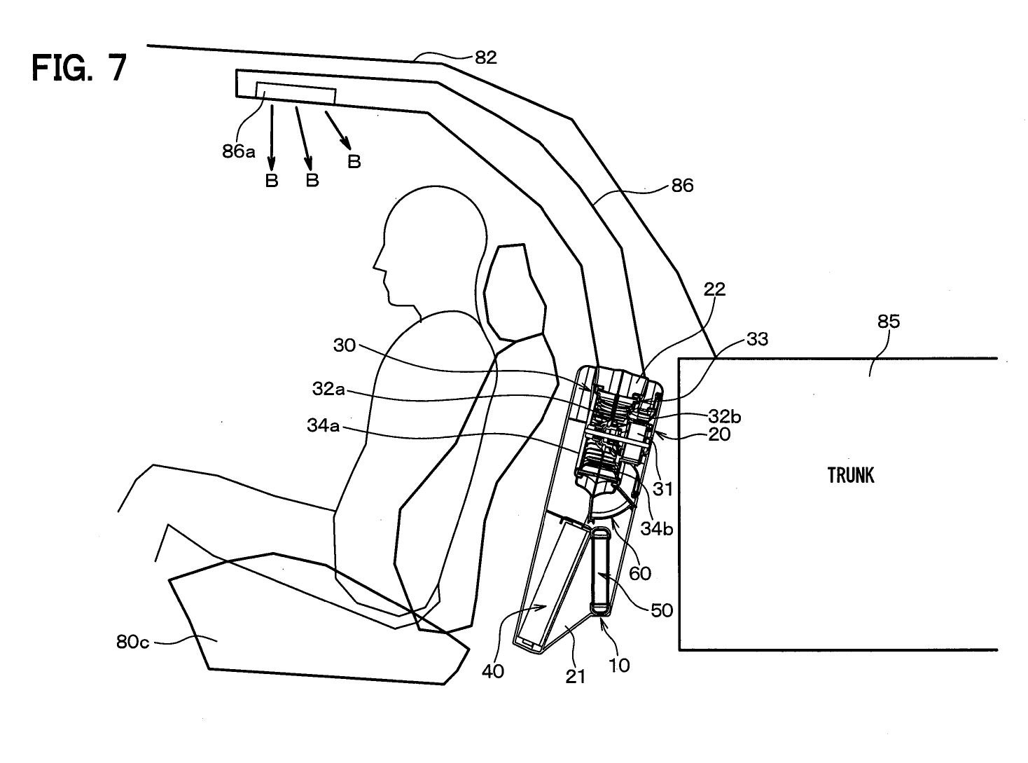

FIG. 7 is a diagram illustrating a condition where the air conditioning unit 10 for a rear seat according to the fifth embodiment of the present disclosure is mounted in a vehicle. FIG. 7 is a diagram of the vehicle compartment when viewed from the width direction (i.e., the left-right direction).

The air conditioning unit 10 for a rear seat according to the present embodiment is arranged in the vehicle compartment on the rear side of the rearmost seat 80d and on a front side with respect to a trunk room 85. The rearmost seat 80d is a seat that is arranged in a rearmost area of the vehicle compartment of the vehicle.

The blowing opening 22 of the air conditioning unit 10 for a rear seat connects to a blowing outlet 86a through a duct 86. The blowing outlet 86a is located above the rearmost seat 80d in the roof part 82. Accordingly, the air conditioning unit 10 for a rear seat of the present embodiment adjusts a temperature of air, which is drawn from the vehicle compartment through the suction port 83a, by the evaporator 40 and the heater core 50 and blows the air from the blowing outlet 86a to a side of the rear seat 80c through the blowing opening 22 and the duct 86 as shown by an arrow B.

According to the above-described present embodiment, similar to the first through fourth embodiments, the portion of the fan case 33 that is provided with at least the suction ports 34a, 34b is arranged inside of the air conditioning case 20. Thus, the suction ports 34a, 34b are surrounded by the inner wall of the air conditioning case 20. Accordingly, the present disclosure provides the same effect as the first through fourth embodiments.

Especially, in a vehicle in which an engine for traveling is disposed on a front area in the vehicle, an engine sound transmitted from the engine for traveling is quiet for a passenger seating the rear seat, and it is required to keep quiet. Accordingly, since the suction ports 34a, 34b are surrounded by the inner wall of the air conditioning case 20, an effect that reduces a noise of the blower 30 can be improved.

### Sixth Embodiment

In the above-described first embodiment, an example in which the evaporator 40 and the heater core 50 are arranged such that the air inlet surfaces 40b, 50b face each other. In a sixth embodiment, the evaporator 40 and the heater core 50 are arranged such that the air outlet surfaces 40a, 50a face each other.

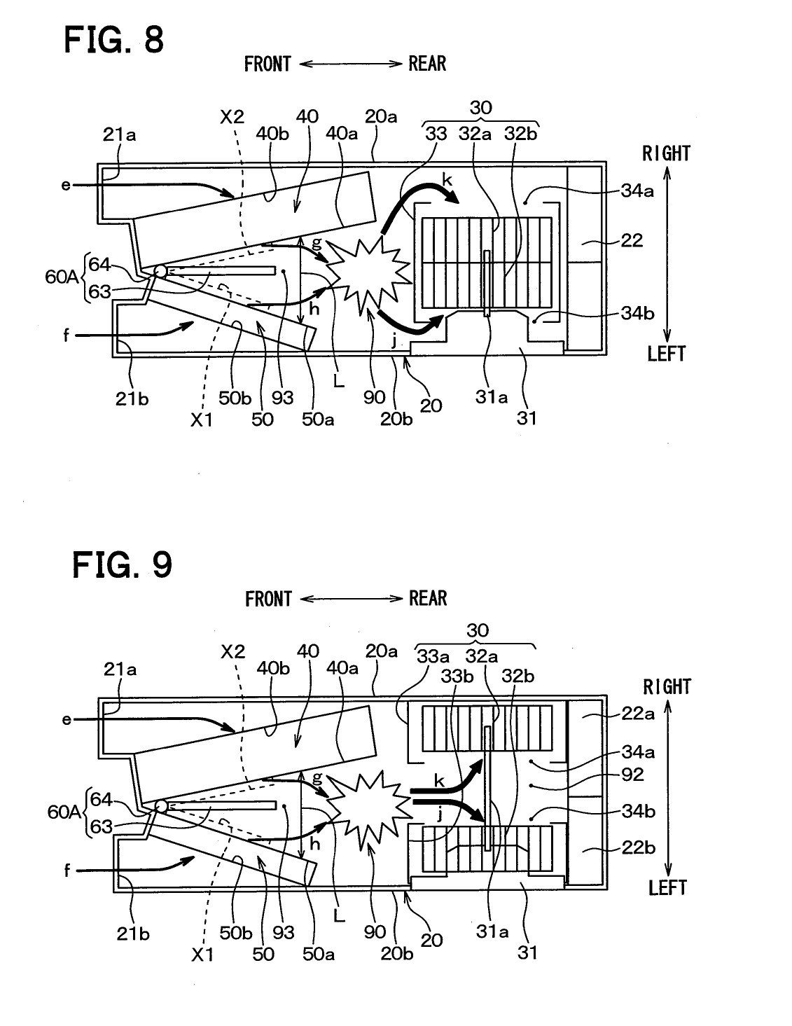

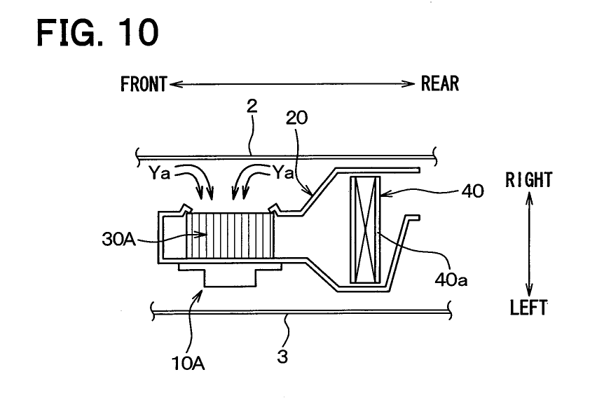

FIG. 8 is a diagram illustrating a condition where the air conditioning unit 10 for a rear seat according to the sixth embodiment of the present disclosure is mounted in a vehicle. In FIG. 8, the same reference numbers as FIG. 3 show the same members, and the explanation of which is omitted.

In the air conditioning unit 10 for a rear seat of the present embodiment, the air conditioning case 20 is provided with introducing ports 21a, 21b instead of the introducing port 21 that is shown in FIG. 3. The introducing port 21a is formed in the air conditioning case 20 on a side of the right wall portion 20a. The introducing port 21b is formed in the air conditioning case 20 on a side of the left wall portion 20b.

The evaporator 40 and the heater core 50 are arranged such that the air outlet surfaces 40a, 50a face each other across an air passage 93. Specifically, the evaporator 40 and the heater core 50 are arranged in parallel with respect to the airflow direction and are arranged in a V-shape such that a distance L between the air outlet surfaces 40a, 50a increases toward a downstream side in the airflow direction. That is, the evaporator 40 and the heater core 50 are arranged such that cool air from the air outlet surface 40a intersects with warm air from the air outlet surface 50a.

An air mix door 60A that is alternative to the air mix door 60 shown in FIG. 3 is arranged between the air outlet surface (i.e., the cool-air blowing surface) 40a of the evaporator 40 and the air outlet surface (i.e., the warm-air blowing surface) 50a of the heater core 50. The air mix door 60A has a door body 63 having a plate shape and a rotation shaft 64 arranged on an end portion of the door body 63 in a planar direction. The air mix door 60A is supported rotatably centered at the rotation shaft 64.

The air mix door 60A adjusts a temperature of conditioned air that is blown into the vehicle compartment from the blowing opening 22 by changing a ratio between an air volume of cool air blowing from the air outlet surface 40a of the evaporator 40 and an air volume of warm air blowing from the air outlet surface 50a of the heater core 50 depending on a position of the air mix door 60A.

When the air mix door 60A is positioned at a position X1 shown in FIG. 8, a max-cool mode in which the air volume of cool air blowing from the evaporator 40 becomes maximum, and the air volume of warm air blowing from the heater core 50 becomes minimum is performed. When the air mix door 60A is positioned at a position X2 shown in FIG. 8, a max-hot mode in which the air volume of cool air blowing from the evaporator 40 becomes minimum, and the air volume of warm air blowing from the heater core 50 becomes maximum is performed.

In the air conditioning case 20, a mixing space 90 is formed between the evaporator 40, the heater core 50 and the suction ports 34a, 34b of the blower 30. In the mixing space 90, cool air blown from the air outlet surface 40a of the evaporator 40 and warm air blowing from the air outlet surface 50a of the heater core 50 are mixed.

According to the present embodiment having the above-described configuration, air flows from the introducing ports 21a, 21b to the blower 30 in the air conditioning case 20 when the electric motor 31 rotates the impellers 32a, 32b of the blower 30.

On this occasion, air flows from the introducing port 21a to the air inlet surface 40b of the evaporator as shown by an arrow e. The air is cooled by refrigerant and blown from the air outlet surface 40a of the evaporator 40 as shown by an arrow g.

On the other hand, air flows from the introducing port 21b to the air inlet surface 50b of the heater core 50 as shown by an arrow f. The air is heated by the engine cooling water (i.e., warm water) and blown from the air outlet surface 50a of the heater core 50 as shown by an arrow h.

Cold air blowing from the evaporator 40 and warm air blowing from the heater core 50 intersect with each other and mixed together. The mixed air is drawn as a conditioned air to the suction ports 34a, 34b as shown by arrows k, j. The drawn air is blown from the blowing opening 22 to the rear side in the vehicle compartment through the fan case 33.

According to the above-described present embodiment, similar to the first through fifth embodiments, the portion of the fan case 33 of the blower 30 that is provided with at least the suction ports 34a, 34b is arranged inside of the air conditioning case 20. Thus, in the air conditioning unit 10 for a rear seat, the suction ports 34a, 34b that are provided with the fan case 33 of the blower 30 are surrounded by the inner wall of the air conditioning case 20. Accordingly, when the blower 30 draws air flowing from the evaporator 40 and the heater core 50 and causes a noise, the inner wall of the air conditioning case 20 can suppress a transmission of the noise into the vehicle compartment. Therefore, similar to the first embodiment, the noise caused when the blower 30 draws air can be shut up in the air conditioning case 20.

In addition, similar to the first embodiment, since the blower 30 draws air from both of the suction ports 34a, 34b, a pressure loss of air drawn by the blower 30 can decrease, and a flow speed of the air can decrease as compared to that of a blower drawing air from a single suction port. Therefore, a noise caused when the blower 30 draws air can be reduced. Thus, a noise transmitting from the blower 30 into the vehicle compartment can be reduced.

According to the present embodiment, the evaporator 40 and the heater core 50 are arranged in a V-shape such that the distance L between the air outlet surfaces 40a, 50a increases toward a downstream side in the airflow direction. Accordingly, the mixing space 90 is provided on a downstream side with respect to the suction ports 34a, 34b of the blower 30 in the airflow direction. Therefore, cold air from the evaporator 40 and warm air from the heater core 50 are mixed in the mixing space 90, and the mixed air is drawn into the suction ports 34a, 34b of the blower 30.

According to the first embodiment, cold air from the evaporator 40 is drawn to the suction port 34a of the blower 30 as a laminar flow, and warm air from the heater core 50 is drawn to the suction port 34b of the blower as a laminar flow. Therefore, the impeller 32a blows cold air, and the impeller 32b blows warm air. Thus, air blown from the impellers 32a, 32b through the blowing opening 22 has a temperature variation.

In contrast, according to the present embodiment, as described above, cold air from the evaporator 40 and warm air from the heater core 50 are mixed in the mixing space 90, and the mixed air is drawn to the suction ports 34a, 34b of the blower 30. Accordingly, the conditioned air that is a mixture of warm air and cold air is drawn by the impeller 32a, 32b and blown from the blowing opening 22 to the rear seat side in the vehicle compartment. Therefore, a performance (i.e., an air mix performance) mixing cool air from the evaporator 40 and warm air from the heater core 50 on an upstream side with respect to the impellers 32a and 32b in the airflow direction can be improved. As a result, a cause of the temperature variation in the air blowing from the blower 30 can be suppressed.

### Seventh Embodiment

In the sixth embodiment, an example in which the impellers 32a, 32b are housed in the common fan case 33. In a seventh embodiment, the impellers 32a, 32b are respectively housed in two fan cases that are independent from each other.

FIG. 9 is a diagram illustrating a condition where the air conditioning unit 10 for a rear seat according to the seventh embodiment of the present disclosure is mounted in a vehicle. In FIG. 9, the same reference numbers as FIG. 8 show the same members, and the explanation of which is omitted.

An air conditioning unit 10 for a rear seat according to the present embodiment has fan cases 33a, 33b instead of the fan case 33. The fan case 33a configures a first housing member that houses the impeller 32a. The fan case 33a is provided with a suction port 34a and a blowing opening 22a. Accordingly, the fan case 33a and the impeller 32a configure a first centrifugal-type blower.

The fan case 33b configures a second housing member that houses the impeller 32b. The fan case 33b is provided with a suction port 34b and a blowing opening 22b. Accordingly, the fan case 33ba and the impeller 32b configure a second centrifugal-type blower.

The fan cases 33a, 33b are arranged on a downstream side with respect to the mixing space 90 in the airflow direction. The fan cases 33a and 33b are arranged such that the suction ports 34a, 34b face each other across the air passage 92 formed in the air conditioning case 20.

According to the present embodiment configured as described above, cold air from the evaporator 40 and warm air from the heater core 50 are mixed in the mixing space 90. The mixed air is drawn as the conditioned air to the suction port 34a of the blower 30 through the air passage 92 as shown by an arrow k. The impeller 32a blows the conditioned air drawn from the suction port 34a to an outer side in the radial direction. The fan case 33a collects the conditioned air blown from the impeller 32a and blows the conditioned air from the blowing opening 22a.

On the other hand, the air mixed in the mixing space 90 is drawn as the conditioned air to the suction port 34b of the blower 30 through the air passage 92 as shown by an arrow j. The impeller 32b blows the conditioned air drawn from the suction port 34b to an outer side in the radial direction. The fan case 33b collects the conditioned air blown from the impeller 32b and blows the conditioned air from the blowing opening 22b.

Thus, the impellers 32a, 32b can blow air, which is drawn into the fan cases 33a, 33b through the suction ports 34a, 34b, from the blowing openings 22a, 22b to the rear seat side in the vehicle compartment.

According to the above-described present embodiment, similar to the first through fifth embodiments, the portion of the fan case 33 of the blower 30 that is provided with at least the suction ports 34a, 34b is arranged inside of the air conditioning case 20. Thus, in the air conditioning unit 10 for a rear seat, the suction ports 34a, 34b provided with the fan cases 33a, 33b of the blower 30 are surrounded by the inner wall of the air conditioning case 20. Thus, similar to the first embodiment, a noise transmitting from the blower 30 into the vehicle compartment can be reduced.

According to the present embodiment, the suction port 34a of the fan case 33a and the suction port 34b of the fan case 33b are arranged to face each other across the air passage 92. The suction ports 34a, 34b are arranged on the downstream side of the mixing space 90 in the airflow direction. Accordingly, cool air from the evaporator 40 and warm air from the heater core 50 are mixed in the mixing space 90, and the mixed air flows to the suction ports 34a, 34b. As a result, the performance (i.e., the air mix performance) mixing cool air and warm air can be further improved. Thus, a cause of the temperature variation in the air blowing from the blower 30 into the vehicle compartment can be suppressed more effectively.

(Other Modifications)

In the first and second embodiments, the air conditioning unit 10 for a rear seat that is disposed between the outer plate 2 located on the right side in the vehicle and the quarter trim 3 is the air conditioning unit of the present disclosure. However, an air conditioning unit 10 for a rear seat that is disposed between the outer plate 2 located on a left side in the vehicle and the quarter trim 3 may be the air conditioning unit of the present disclosure instead.

In the first through seventh embodiments, an example in which the evaporator 40 and the heater core 50 are used as the heat exchanger is described. However, one of the evaporator 40 and the heater core 50 may be the heat exchanger. For example, a so-called “cooling-specified” air conditioning unit 10 for a rear seat in which the evaporator 40 of the evaporator 40 and the heater core 50 is arranged in the air conditioning case 20 may be the air conditioning unit of the present disclosure.

In the first through seventh embodiments, an example in which the air conditioning unit 10 for a rear seat blowing air to the rear seat side in the vehicle compartment is the air conditioning unit of the present disclosure is described. However, an air conditioning unit blowing air to a specified area except for the rear seat side in the vehicle compartment may be the air conditioning unit of the present disclosure. In this case, an arrangement location of the air conditioning unit of the present disclosure may be any location as long as being on a rear side with respect to the instrument panel 1d in the vehicle compartment. For example, an air conditioning unit blowing air to a front seat side may be the air conditioning unit of the present disclosure.

In the first through seventh embodiment, an example in which the evaporator 40 is used as the cooling heat exchanger cooling air by refrigerant is described. However, a peltier element may be used as the cooling heat exchanger and cools air.

In the first through seventh embodiments, an example in which the heater core 50 is used as the heating heat exchanger heating air by engine cooling water (i.e., warm water) is described. However, an electric heater may be used as the heating heat exchanger and heats air.

In the first and second embodiments, an example in which the sound absorption member 70 is arranged in the air conditioning case 20 is described. However, the heat absorption member 70 may be omitted from the air conditioning case 20.

In the first and second embodiments, an example in which the sound absorption member 70 is arranged on the side of the suction port 34a of the air conditioning case 20 is described. However, the sound absorption member 70 may be arranged on a side of the suction port 34b in the air conditioning case 20. Alternatively, the sound absorption member 70 may be arranged on both sides of the suction ports 34a, 34b in the air conditioning case 20. Further, in the third through seventh embodiments, the sound absorption member 70 may be arranged similar to the first and second embodiments.

In the first through seventh embodiments, an example in which the evaporator 40 is arranged such that the air outlet surface 40a faces in the left-right direction is described. However, the evaporator 40 may be arranged such that the air outlet surface 40a faces in a direction other than the left-right direction.

In the first through seventh embodiments, an example in which the heater core 50 is arranged such that the air outlet surface 50a faces in the left-right direction is described. However, the heater core 50 may be arranged such that the air outlet surface 50a faces in a direction other than the left-right direction instead.

In the first through seventh embodiments, an example in which a centrifugal-type blower is used as the blower 30 is described. However, a blower other than the centrifugal-type blower may be used as long as being a blower that has the suction ports 34a, 34b.

In the first through seventh embodiments, an example in which the suction ports 34a, 34b of the blower 30 face in the left-right direction. However, the suction ports 34a, 34b of the blower 30 may face in a direction (e.g., the upper-lower direction) other than the left-right direction.

A vehicle in which the air conditioning unit 10 for a rear seat of the present disclosure is mounted may be any vehicle as long as having a space for mounting the air conditioning unit 10 for a rear seat between the outer plate 2 and the quarter trim 3.

In the first through seventh embodiments, an example in which the electric motor operates the air mix door 60 (60A) is described. However, the air mix door 60 (60A) may be operated by an operational force that is generated when a user operates an operation part.

Moreover, the air conditioning unit 10 for a rear seat of the sixth and seventh embodiments may be arranged in the center console box 81 similar to the third embodiment. The air conditioning unit 10 for a rear seat may be arranged in the roof part 82 similar to the fourth embodiment, or the air conditioning unit 10 for a rear seat may be arranged on the rear side of the rearmost seat 80d in the vehicle compartment similar to the fifth embodiment. Furthermore, an area in which the air conditioning unit 10 for a rear seat of the present disclosure is arranged may be any area as long as being an area on a rear side with respect to the instrument panel in the vehicle compartment.

It should be understood that the present disclosure is not limited to the above-described embodiments and intended to cover various modification within a scope of the present disclosure as described hereafter. Above-described embodiments are not unrelated to each other and can be combined as required except for a case of being clearly improper.

What is claimed is:

1.-15. (canceled)

16. An air conditioning unit comprising:
an air conditioning case that is arranged in a vehicle compartment on a rear side with respect to an instrument panel in a traveling direction of a vehicle and forms an air passage delivering air toward a specified area of the vehicle compartment;
a blower that has at least first and second impellers and a fan case housing the first and second impellers and ventilates the air in the air conditioning case by drawing and blowing air, by using a rotation of the first and second impellers, through first and second suction ports formed in the fan case; and
a heat exchanger that is arranged in the air conditioning case on an upstream side of the blower in an airflow direction and exchanges heat of the air, wherein
the blower draws air from the heat exchanger and blows the air to the specified area of the vehicle compartment,
the fan case has a portion in which at least the first and second suction ports are formed, and the portion is arranged inside of the air conditioning case,
the air conditioning case (i) is arranged in the vehicle compartment on a rear side with respect to a front seat in the traveling direction, (ii) is disposed between an inner wall of the vehicle compartment and an outer plate that is located on an outer side of the vehicle in a left-right direction, and (iii) forms the air passage that delivers air toward a rear seat in the vehicle compartment, and
the first and second suction ports are surrounded by an inner wall of the air conditioning case.

17. An air conditioning unit comprising:
an air conditioning case that is arranged in a vehicle compartment on a rear side with respect to an instrument panel in a traveling direction of a vehicle and forms an air passage delivering air toward a specified area of the vehicle compartment;
a blower that has at least first and second impellers and a fan case housing the first and second impellers and ventilates the air in the air conditioning case by drawing and blowing air, by using a rotation of the first and second impellers, through first and second suction ports formed in the fan case; and
a heat exchanger that is arranged in the air conditioning case on an upstream side of the blower in an airflow direction and exchanges heat of the air, wherein
the blower draws air from the heat exchanger and blows the air to the specified area of the vehicle compartment,
the fan case has a portion in which at least the first and second suction ports are formed, and the portion is arranged inside of the air conditioning case,
the air conditioning case is arranged in a roof part in the vehicle compartment, and
the first and second suction ports are surrounded by an inner wall of the air conditioning case.

18. The air conditioning unit according to claim 16, wherein
a sound absorption member absorbing sound that is caused when the blower draws air is disposed in the air conditioning case.

19. The air conditioning unit according to claim 16, further comprising:
a heating heat exchanger as the heat exchanger heating the air and blowing warm air as the heat exchanger; and
a cooling heat exchanger as the heat exchanger cooling the air and blowing cool air, wherein
the heating heat exchanger and the cooling heat exchanger are arranged to be adjacent to each other in a direction intersecting with the airflow direction.

20. The air conditioning unit according to claim 19, wherein
the heating heat exchanger and the cooling heat exchanger are arranged such that warm air blowing from the heating heat exchanger intersects with cool air blowing from the cooling heat exchanger.

21. The air conditioning unit according to claim 19, wherein
the heating heat exchanger has a warm-air blowing surface blowing warm air,
the cooling heat exchanger has a cool-air blowing surface blowing cool air, and
the heating heat exchanger and the cooling heat exchanger are arranged such that the warm-air blowing surface and the cool-air blowing surface face each other and a distance between the warm-air blowing surface and the cool-air blowing surface increases toward a downstream side in the airflow direction.

22. The air conditioning unit according to claim 20, wherein
the fan case has (i) a first housing member that is provided with the first suction port and houses the first impeller and (ii) a second housing member that is provided with the second suction port and houses the second impeller, and
the first and second housing members are arranged in the air conditioning case on a downstream side of a mixing space in which air passing through the heating heat exchanger intersects with air passing through the cooling heat exchanger.

23. The air conditioning unit according to claim 22, wherein
the first and second housing members are arranged such that the first and second suction ports face each other across the air passage in the air conditioning case.

24. The air conditioning unit according to claim 19, further comprising
an air mix door changing a ratio between an air volume passing through the heating heat exchanger and an air volume passing through the cooling heat exchanger.

25. The air conditioning unit according to claim 18, wherein
one of the first and second suction ports is open toward one side in a left-right direction of the vehicle, and the other one of the first and second suction ports is open toward the other side in the left-right direction.

26. The air conditioning unit according to claim 16, further comprising:
a heating heat exchanger as the heat exchanger heating the air; and
a cooling heat exchanger as the heat exchanger cooling the air, wherein
the cooling heat exchanger and the heating heat exchanger are arranged in series in the airflow direction.

27. The air conditioning unit according to claim 26, further comprising:
a bypass passage that is provided in the air conditioning case and delivers air passing through the cooling heat exchanger to bypass the heating heat exchanger; and
an air mix door changing a ratio between an air volume passing through the heating heat exchanger and an air volume passing through the cooling heat exchanger.
